(19) United States
(12) Patent Application Publication
(10) Pub. No.: US 2008/0053428 A1
(43) Pub. Date: Mar. 6, 2008

(54) Wire grid pepper grill

(75) Inventor: Joseph Roy Pineau, Wichita Falls, TX (US)

Correspondence Address: Joseph Roy Pineau, 4325 Berwick Drive, Wichita Falls, TX, 76309-4811, US

(73) Assignee: Joseph Roy Pineau, Wichita Falls, TX (US)

(21) Appl. No.: 11/513,937

(22) Filed: Aug. 31, 2006

(51) Int. Cl. A47J 37/00

(52) U.S. Cl. 126/25 R

(57) ABSTRACT

Existing devices are being marketed as pepper grills designed to hold peppers in an upright position while cooking. Peppers are cored and then stuffed with various items such as cream cheese. The devices consist of a horizontal metal plate with holes cut to insert the peppers. The inflexibility of the sides of the holes fails to provide sufficient hold on the peppers as they cook and soften. This allows them to fall over and the contents spill out onto the grill. Also, the bottom of the pepper sticking down through the hole receives the majority of the heat from below. My design uses a metal frame with wires crosshatched rather than holes to support the peppers. The tension of the wires holds the peppers in place more firmly. The design also allows for more even cooking by allowing hot air to flow up through the device.

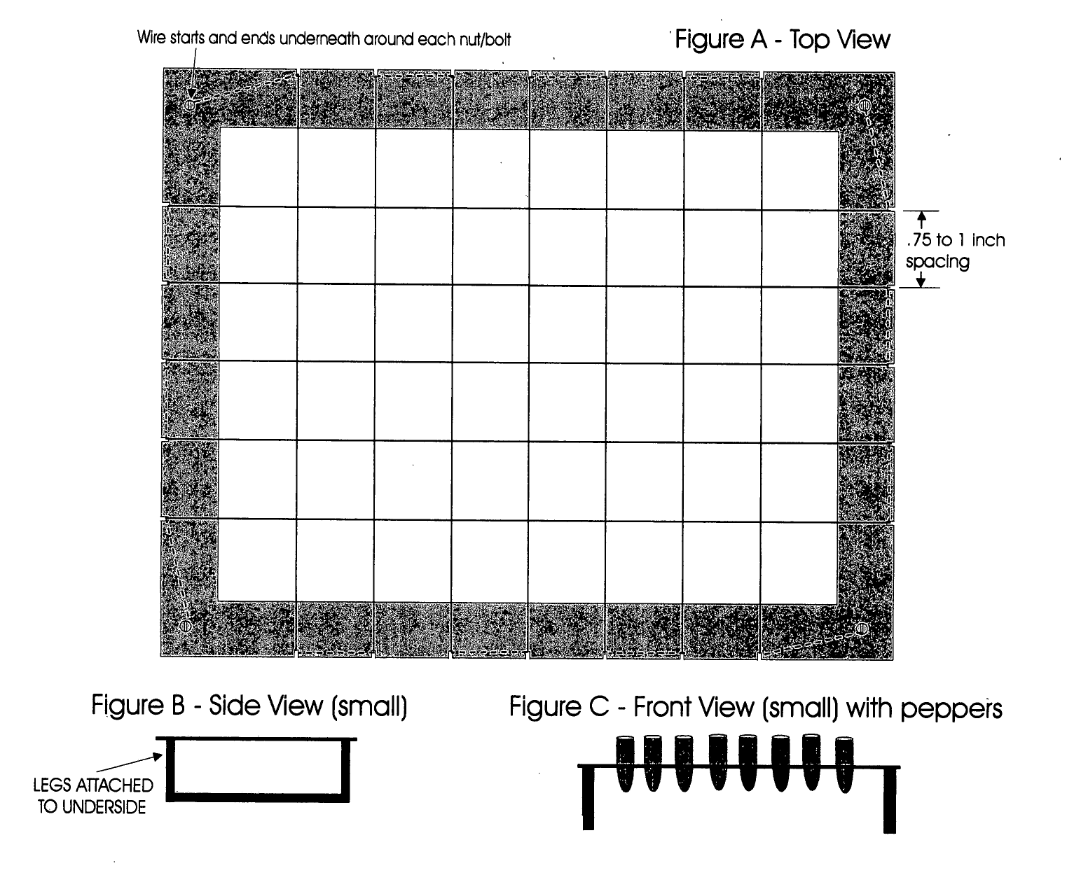

Current commercially available pepper grills consist of a flat piece of metal with holes cut in it for insertion of the peppers (most often cored and stuffed). As peppers cook, they soften and often fall over in the process. This allows the stuffing to leak out onto the pepper grill or the oven creating an unusable mess

This design uses wire attached to a rigid frame in a crosshatched pattern (see FIG. A—Sheet 1) with spacing sufficient to accommodate stuffed peppers or other food items between them. The wires provide a flexible tension on the sides of the peppers and keep them in place vertically (see FIG. C—Sheet 1)

The frame can be made from any metal or other material capable of withstanding heat in excess of 500 degrees with no appreciable deformation. It can be either one-piece or made from separate parts. The frame can be varied in overall dimension as desired to accommodate different numbers of items.

The wire should be non corrosive and spaced at sufficient intervals to accommodate inserted peppers or other food items to be grilled. Spacing can be either constant or varied to accommodate different size peppers or other food items. Attachment of each end of the wire(s) is done using a nut and bolt combination through the frame or a set-screw threaded into the frame. Threading of the wires can be done using slots cut into the frame (see FIG. A—Sheet 1) or by any other method which will keep the wires in place.

The legs can be of any design and attached in any manner having a horizontal component on two ends so that they will support the grill horizontally above the oven or barbeque rack (see FIG. B—Sheet 1).

The open design of the center section of this device also allows for a more even cooking of the peppers since convective air flow carries the heat through the center of the device rather than around the solid metal of the older design. Comparison tests have proven this fact.

### DESCRIPTION OF DRAWINGS (SHEET 1 OF 1): WIRE GRID PEPPER GRILL

Three figures represent the general design in concept.

FIG. A: Top View of frame with wires attached. Solid lines are wire segments on top of frame. Dotted lines are wire segments on the underside of frame. Dimensions are intentionally left out in most cases where they are variable based on what size of grill is desired. Screws or Nut/Bolt combinations are in all corners and show where wire segments in this configuration will be secured at their respective ends.

FIG. B: Side view of frame showing possible attachment locations of legs.

FIG. C: Front view showing legs at ends and hypothetical positions of peppers as inserted for cooking.

1. I claim the use of a wire grid attached to a horizontal rigid frame in a crosshatched fashion with wire interval spacing and tension sufficient to insert peppers or other similar foods in an upright (vertical) position and hold them in place while cooking in a barbeque grill or oven.

2. I claim the use of wires to support cooked items in order to allow hot air convection to rise through the center of the grill and cook items more evenly than currently marketed pepper grill designs with holes cut in a metal plate.
